(19) United States
(12) Patent Application Publication
(10) Pub. No.: US 2025/0183800 A1
(43) Pub. Date: Jun. 5, 2025

(54) DC-DC CONVERTER

(71) Applicant: Webasto SE, Stockdorf (DE)

(72) Inventors: Bernhard Vogl, Stockdorf (DE); Robert Ruef, Stockdorf (DE)

(21) Appl. No.: 18/959,142

(22) Filed: Nov. 25, 2024

(30) Foreign Application Priority Data
Nov. 30, 2023 (DE) 10 2023 212 026.7

(51) Int. Cl. H02M 3/158; H02M 1/00

(52) U.S. Cl. CPC H02M 3/1582; H02M 1/0009

(57) ABSTRACT

A method for operating a DC-DC converter (300) which contains a buck-boost converter (10) with an inductor (L) and a plurality of switching elements (S1-S4), comprises measuring a current (I) flowing through the inductor (L) and performing the following method steps: a) comparing the current with a first threshold current value (Ival), b) setting the buck-boost converter into a first switching state (BOOST ON) at the beginning of a switching cycle if the current is below the first threshold current value, or setting the buck-boost converter into a second switching state (BOOST OFF, BUCK ON) at the beginning of the switching cycle if the current is not below the first threshold current value, c) if the buck-boost converter is operated in the first switching state, comparing the current with the first threshold current value (Ival) and setting the buck-boost converter into the second switching state as soon as the current reaches the first threshold current value, d) if the buck-boost converter is operated in the second switching state, comparing the current with a second threshold current value (Ipk) which is greater than the first threshold current value and setting the buck-boost converter into the third switching state (BUCK OFF) as soon as the current reaches the second threshold current value, and repeating steps a) to d) after expiry of the predetermined period duration (Tc).

This application claims priority to German Patent Application No. DE 10 2023 212 026.7 filed Nov. 30, 2023, which application is hereby incorporated by reference as if set forth in its entirety herein.

The present invention relates to a DC-DC converter, in particular a DC-DC converter which is designed as a buck-boost converter, and to a method for driving such a DC-DC converter.

Buck-boost converters can convert an input DC voltage both into a lower output voltage (step-down mode, buck mode) and into a higher output voltage (step-up mode, boost mode).

In prior art, buck-boost converters are known which contain an inductor and a plurality of switching elements which realize the step-up or step-down of the input voltage by alternating switching.

For driving such buck-boost converters, two methods are known in particular from prior art. In the case of pulse width modulation (PWM), the switches are driven with switching signals which have a predetermined duty cycle, that is to say a predetermined ratio between the switch-on time of a switching element and the period duration of a switching cycle. In the case of peak current control, the current coil current is compared with a threshold value and the switching takes place when the coil current reaches the threshold value. In this case, therefore, the duty cycle can change as a function of the coil current.

In both cases, the drive circuit of the switching elements must in each case distinguish whether the converter is currently in step-up mode or in step-down mode. Depending on the current operating state, the switching transistors contained in the buck-boost converter must be driven differently.

In addition, the transition zone between step-down mode and step-up mode (buck-boost) is difficult to regulate. In this case, the drive circuit must switch cyclically between the two operating modes. Driving the switching transistors, for example by software, is therefore complex and time-consuming, but also time-critical.

U.S. Pat. No. 2,023,223,852 A1 describes such a DC-DC converter, its driving in different operating modes and the switching between these operating modes.

It is an object of the present invention to provide a DC-DC converter and a method for driving it, which are improved over the prior art.

The object is achieved by the subject matter of the independent claims. Further embodiments of the invention are each specified in the dependent claims. In this case, the subject matter of an independent claim can also be embodied by features of the dependent claims of another independent claim.

The method according to the invention serves for operating a DC-DC converter which contains a buck-boost converter with an inductor and a plurality of switching elements, wherein a step-up operation is achieved by alternating switching of the switching elements between a first switching state BOOST ON and a second switching state BOOST OFF, BUCK ON and a step-down operation is achieved by alternating switching between the second switching state BOOST OFF, BUCK ON and a third switching state BUCK OFF, wherein the switching between the switching states takes place periodically in switching cycles with a predetermined period duration. The method comprises measuring a current flowing through the inductor and carrying out the following method steps:
a) comparing the current with a first threshold current value,
b) setting the buck-boost converter into the first switching state at the beginning of a switching cycle if the current is below the first threshold current value, or setting the buck-boost converter into the second switching state at the beginning of the switching cycle if the current is not below the first threshold current value,
c) if the buck-boost converter is operated in the first switching state, comparing the current with the first threshold current value and setting the buck-boost converter into the second switching state as soon as the current reaches the first threshold current value,
d) if the buck-boost converter is operated in the second switching state, comparing the current with a second threshold current value which is greater than the first threshold current value, and setting the buck-boost converter into the third switching state as soon as the current reaches the second threshold current value, and
repeating steps a) to d) after expiry of the predetermined period duration.

In an advantageous further embodiment, the buck-boost converter is set into the first switching state before step a) or b).

In an advantageous further embodiment, the buck-boost converter is set into a fourth switching state at the end of the switching cycle before expiry of the predetermined period duration, which fourth switching state is designed for regenerating internal supply voltages of driver circuits for the switching elements (S1, S3) connected to an input terminal or an output terminal of the buck-boost converter.

In an advantageous further embodiment, the first threshold current value and/or the second threshold current value and/or the predetermined period duration are obtained from operating data of a device in which the DC-DC converter is used.

In an advantageous further embodiment, the operating data of the device comprises maximum power point tracking data of a current generator and/or the maximum current for charging a current storage and/or the maximum voltage for charging the current storage.

The DC-DC converter according to the invention contains a buck-boost converter with an inductor and a plurality of switching elements, wherein a step-up operation is achieved by alternating switching of the switching elements between a first switching state BOOST ON and a second switching state BOOST OFF, BUCK ON and a step-down operation is achieved by alternating switching between the second switching state BOOST OFF, BUCK ON and a third switching state BUCK OFF, and a control device for controlling the DC-DC converter. The control device is configured or programmed to operate the DC-DC converter by means of the method according to the invention.

In an advantageous further embodiment, the buck-boost converter contains an input terminal for applying an input voltage, an output terminal for outputting an output voltage and a common ground, wherein a first end of the inductor is connected via a first switching element to the input terminal and via a second switching element to the ground, and a second end of the inductor is connected via a third switching element to the output terminal OUT and via a fourth switching element to the ground GND.

In an advantageous further embodiment, the second and the third switching element are opened and the first and the fourth switching element are closed in the first switching state and/or the second and the fourth switching element are opened and the first and the third switching element are closed in the second switching state and/or the first and the fourth switching element are opened and the second and the third switching element are closed in the third switching state and/or the first and the third switching element are opened and the second and the fourth switching element are closed in the fourth switching state.

In an advantageous further embodiment, the control device contains a microcontroller.

In an advantageous further embodiment, the comparison of the current with the first threshold current value and/or with the second threshold current value is carried out by means of comparators integrated in the hardware of the microcontroller.

The current generating device according to the invention contains a current generator for generating electrical energy at a first voltage, a current storage for storing the electrical energy generated by the current generator at a second voltage and a DC-DC converter according to the invention.

The computer program according to the invention contains instructions which cause a control unit to generate control signals for carrying out a method according to the invention when the computer program is executed in the control unit.

Further features and expedients of the invention result from the description of an exemplary embodiment with reference to the attached drawings.

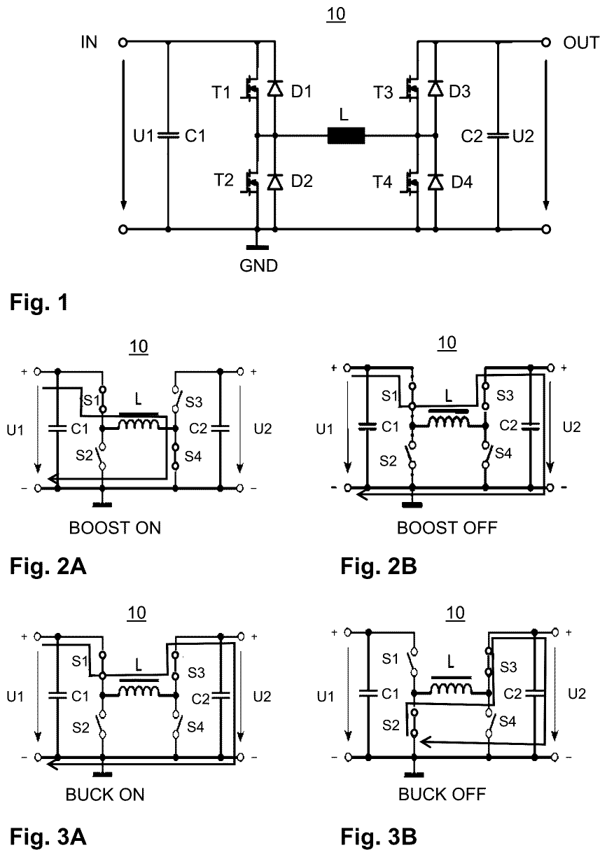

FIG. 1 shows a circuit diagram of a buck-boost converter which is suitable for carrying out the present invention.

FIGS. 2A and 2B show a simplified circuit diagram of the buck-boost converter in boost mode, wherein FIG. 2A shows a switching state in the BOOST-ON mode and FIG. 2B shows a switching state in the BOOST-OFF mode.

FIGS. 3A and 3B show a simplified circuit diagram of the buck-boost converter in buck mode, wherein FIG. 3A shows a switching state in the BUCK-ON mode and FIG. 3B shows a switching state in the BUCK-OFF mode.

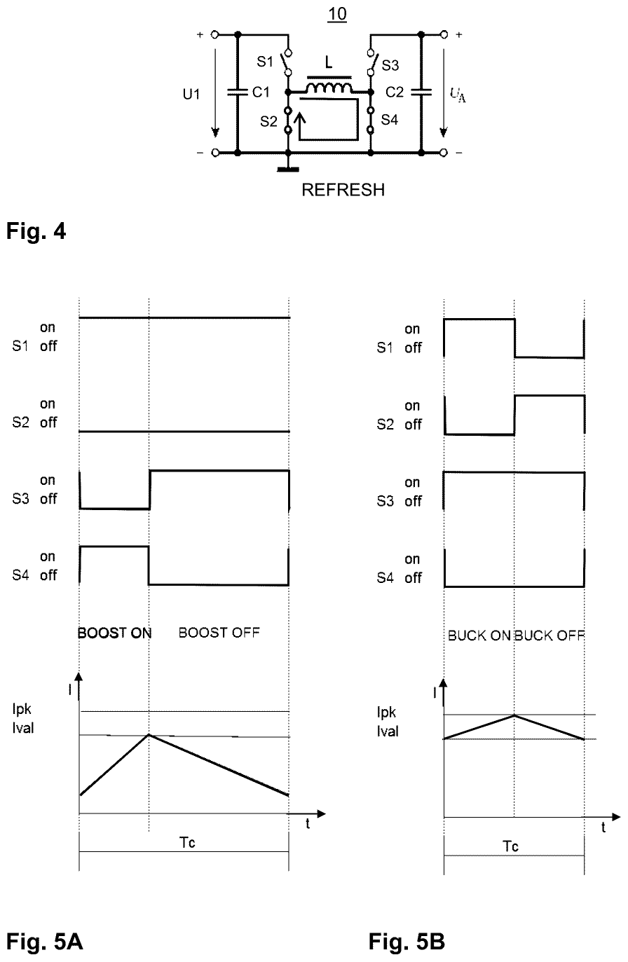

FIG. 4 shows a simplified circuit diagram of the buck-boost converter in REFRESH mode.

FIGS. 5A and 5B show time diagrams for an operation of the buck-boost converter, wherein FIG. 5A shows time diagrams for a step-up mode and FIG. 5B shows time diagrams for a step-down mode.

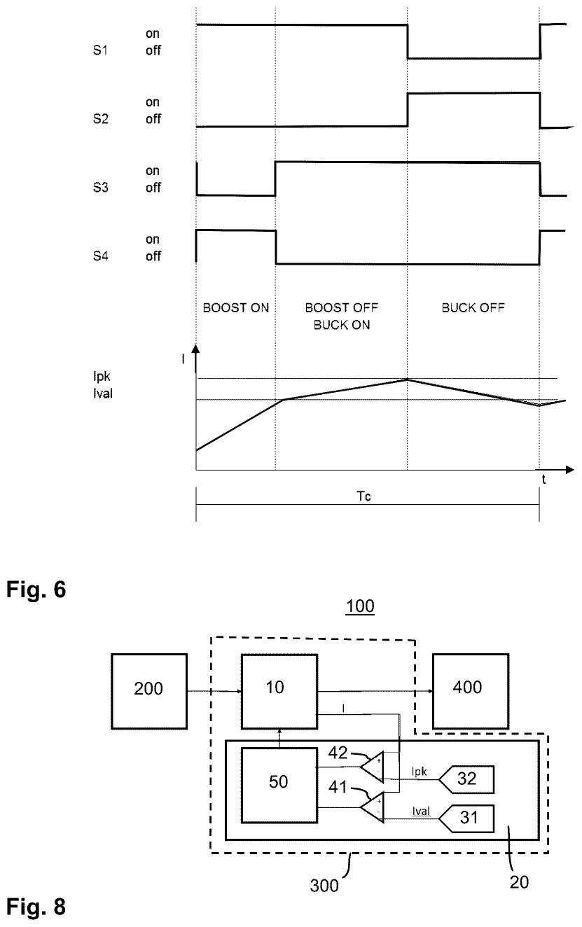

FIG. 6 shows time diagrams for an operation of the buck-boost converter according to a method of the present invention.

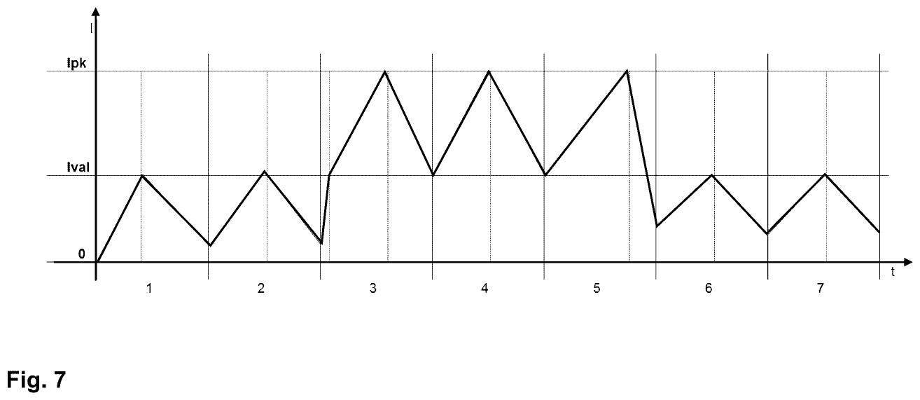

FIG. 7 shows an example of a current profile during an operation of the buck-boost converter according to the method of the present invention.

FIG. 8 shows a block diagram of a current generating device which contains a DC-DC converter according to the present invention.

An embodiment of the present invention is described below with reference to the attached drawings.

An example of a buck-boost converter on which the present invention is based is shown in FIG. 1.

The buck-boost converter 10 has an input terminal IN, an output terminal OUT and a common ground GND. An input voltage U1 is applied between the input terminal IN and ground GND, and an output voltage U2 is output between the output terminal OUT and ground GND. A first capacitor C1 (input capacitor) is connected between the input terminal IN and ground GND, and a second capacitor C2 (output capacitor) is connected between the output terminal OUT and ground GND.

As a current storage element, the buck-boost converter 10 contains an inductor L. A first end of the inductor L is connected via a first transistor T1 and a first diode D1 to the input terminal IN and via a second transistor T2 and a second diode D2 to the ground GND. A second end of the inductor L is connected via a third transistor T3 and a third diode D3 to the output terminal OUT and via a fourth transistor T4 and a fourth diode D4 to the ground GND. The transistors T1-T4 serve as switching elements of the buck-boost converter 10 and the diodes D1-4 serve as freewheeling diodes for the switching transistors.

The different operating modes of the buck-boost converter 10 are explained below with reference to FIGS. 2A, 2B, 3A, 3B and 4. Instead of the switching transistors T1-T4 shown in FIG. 1 with their antiparallel-connected freewheeling diodes D1-D4, switching elements S1-S4 are generally illustrated in these figures. The current path formed in accordance with the switching states of the switching elements S1-S4 is illustrated in the figures by a line with an arrow.

A step-up operation (boost mode) of the buck-boost converter 10 is achieved by alternating switching between a BOOST-ON mode and a BOOST-OFF mode. FIGS. 2A and 2B show a simplified circuit diagram of the buck-boost converter 10 in step-up mode, wherein FIG. 2A shows a switching state in the BOOST-ON mode and FIG. 2B shows a switching state in the BOOST-OFF mode.

In step-up operation or boost mode, the switching element S1 is permanently closed (switched on, on) and the switching element S2 is permanently opened (switched off, off). The step-up of the input voltage takes place by alternating opening and closing of the switching elements S3 and S4.

In the BOOST-ON mode, the switching element S3 is opened and the switching element S4 is closed. In the BOOST-OFF mode, the switching element S3 is closed and the switching element S4 is opened.

A step-down operation (buck mode) of the buck-boost converter 10 is achieved by alternating switching between a BUCK-ON mode and a BUCK-OFF mode. FIGS. 3A and 3B show a simplified circuit diagram of the buck-boost converter 10 in step-down mode, wherein FIG. 3A shows a switching state in the BUCK-ON mode and FIG. 3B shows a switching state in the BUCK-OFF mode.

In step-down operation or buck mode, the switching element S3 is permanently closed and the switching element S4 is permanently opened. The step-down of the input voltage takes place by alternating opening and closing of the switching elements S1 and S2.

In the BUCK-ON mode, the switching element S1 is closed and the switching element S2 is opened. From the switching states of the individual switching elements S1-S4, the BUCK-ON mode thus corresponds to the BOOST-OFF mode. In the BUCK-OFF mode, the switching element S1 is opened and the switching element S2 is closed.

Since the switching states of the switching elements S1-S4 in the BUCK-ON mode correspond to those in the BOOST-OFF mode, only three of the four possible switching states are covered by the four modes described above. FIG. 4 shows a simplified circuit diagram of the buck-boost converter 10 in the fourth switching state.

In this case, the switching elements S1 and S3 are opened and the switching elements S2 and S4 are closed. As a result, both ends of the inductor L are connected to ground.

This state may be used to enable the driver circuits for the high-side switching elements S1 and S3 to regenerate their internal supply voltage by means of an internal boost circuit. It is therefore referred to as REFRESH mode and may be additionally used at the end of a switching cycle before the beginning of the next switching cycle.

FIGS. 5A and 5B show timing diagrams for an operation of the buck-boost converter 10, wherein FIG. 5A shows timing diagrams for a step-up mode (boost mode) and FIG. 5B shows time diagrams for a step-down mode (buck mode). The switching of the switching elements S1-S4 takes place periodically in switching cycles with a period duration Tc.

In step-up mode, the switching element S3 is opened and the switching element S4 is closed at the beginning of a switching cycle, as a result of which the buck-boost converter 10 is set into the BOOST-ON mode. A current I, which increases continuously, flows from the input terminal IN through the inductor L to ground GND. This current I is measured and compared with a first threshold current value Ival.

As soon as the current I reaches the first threshold current value Ival, the switching element S3 is closed and the switching element S4 is opened, as a result of which the buck-boost converter 10 is set into the BOOST-OFF mode. The current I flowing from the input terminal IN through the inductor L flows into the capacitor and charges it. In the process, the current I decreases continuously.

In step-down mode, the switching element S1 is closed and the switching element S2 is opened at the beginning of a switching cycle, as a result of which the buck-boost converter 10 is set into the BUCK-ON mode. A current I flows from the input terminal IN through the inductor L into the capacitor and charges it. In the process, the current I increases continuously. This current I is measured and compared with a second threshold current value Ipk which is greater than the first threshold current value Ival.

Even if the BUCK-ON mode corresponds to the BOOST-OFF mode from the switching states of the switching elements S1-S4, it differs from the latter in that the current I flowing through the inductor L increases in the BUCK-ON mode because the input voltage U1 in step-down mode is greater than the output voltage U2, while it decreases in the BOOST-OFF mode because the input voltage U1 in step-up mode is less than the output voltage U2.

As soon as the current I reaches the second threshold current value Ipk, the switching element S1 is opened and the switching element S2 is closed, as a result of which the buck-boost converter 10 is set into the BUCK-OFF mode. The current I flowing from the input terminal IN through the inductor L continues to flow into the capacitor and charges it further. In the process, the current I decreases continuously.

In prior art, it is decided on the basis of information received externally about the ratio between the input voltage U1 and the output voltage U2 whether the buck-boost converter 10 is to be driven in step-up mode or in step-down mode, and the driving is adapted accordingly.

In order to eliminate this disadvantage of the prior art, driving is realized according to the present invention with a time profile as illustrated in FIG. 6.

In the case of the current profile illustrated in FIG. 6, the current I flowing through the inductor L is less than the first threshold current value Ival at the beginning of the switching cycle. At the beginning of the switching cycle, the buck-boost converter 10 is set into a first switching state which corresponds to the BOOST-ON mode (switching elements S1 and S4 closed, switching elements S2 and S3 opened). A current I, which increases continuously, flows from the input terminal IN through the inductor L to ground GND. This current I is measured and compared with the first threshold current value Ival.

As soon as the current I reaches the first threshold current value Ival, the buck-boost converter 10 is set into a second switching state which corresponds to the BOOST-OFF mode (switching elements S1 and S3 closed, switching elements S2 and S4 opened). The current I flowing through the inductor L flows into the capacitor and charges it. This current I is measured and compared with the second threshold current value Ipk.

Depending on whether the input voltage U1 is less than or greater than the output volt-age U2, the current I decreases again or it increases further. In the case of the current profile illustrated in FIG. 6, the current increases further, that is to say the input voltage is greater than the output voltage.

As soon as the current I reaches the second threshold current value Ipk, the buck-boost converter 10 is set into a third switching state which corresponds to the BUCK-OFF mode (switching elements S2 and S3 closed, switching elements S1 and S4 opened). The current I flowing from the input terminal IN through the inductor L continues to flow into the capacitor and charges it further, but decreases continuously in the process.

After expiry of the predetermined period duration Tc, the next switching cycle begins, and the buck-boost converter 10 is set back into the first switching state.

Owing to the fact that the switching state in the BOOST-OFF mode corresponds to that in the BUCK-ON mode, the switching cycle contains the sequence BUCK ON/BUCK OFF, as a result of which a step-down of the input voltage U1 is realized. The preceding BOOST-ON mode merely supports the following BUCK-ON mode during the charging of the inductor L.

If, in the case of an alternative time profile, the current I flowing through the inductor L decreases again after the switching into the second switching state or at least does not increase up to the second threshold current value Ipk, the second switching state is maintained until expiry of the predetermined period duration Tc. The switching cycle therefore contains the sequence BOOST ON/BOOST OFF, as a result of which a step-up of the input voltage U1 is realized.

If the current I flowing through the inductor L has already exceeded the first threshold current value Ival at the beginning of the switching cycle, the buck-boost converter 10 is set immediately into the second switching state according to the actuation described above after the setting into the first switching state. Alternatively, the buck-boost converter 10 can also be set directly into the second switching state without first being set into the first switching state.

As a result of the sequence of the switching states described above, the drive circuit of the switching elements no longer has to distinguish whether the converter is currently in step-down mode or in step-up mode, and it also no longer needs to carry out the sequence of the switching states accordingly differently. Depending on how the current I flowing through the inductor L changes after the switching into the second state, the correct operating mode is automatically selected: the step-up mode is selected by the sequence BOOST ON/BOOST OFF and the step-down mode is selected by the sequence BOOST ON/BUCK ON/BUCK OFF or merely BUCK ON/BUCK OFF.

FIG. 7 shows an example of a time profile of the current I flowing through the inductor L. Seven switching cycles 1-7, during which the ratio between input voltage U1 and output voltage U2 changes a number of times, are illustrated in a simplified manner for the purpose of illustration. In practice, such changes will extend over substantially more switching cycles, because the voltage ratio changes only slightly during a period duration Tc.

In the first two switching cycles 1, 2, the input voltage U1 is lower than the output voltage U2, and the buck-boost converter 10 operates with the sequence BOOST ON/BOOST OFF in step-up operation or boost mode. In the switching cycle 3, the input voltage U1 has increased above the output voltage U2, and the buck-boost converter 10 transitions into the step-down operation or buck mode with the sequence BOOST ON/BUCK ON/BUCK OFF. In the switching cycles 4, 5, the buck-boost converter 10 continues to be operated with the sequence BUCK ON/BUCK OFF in step-down operation or buck mode, wherein the current I in the switching cycle 5 falls to a value below the first current threshold value Ival as a result of the drop in the input voltage U1 below the output voltage U2. In the switching cycles 6, 7, the buck-boost converter 10 again operates with the sequence BOOST ON/BOOST OFF in step-up operation or boost mode.

The actuation of the buck-boost converter is greatly simplified by the method described above. The switching states are activated in a sequence which takes place as a function of the measured coil current I. As a result of the initialization of the converter in boost-on operation, safe and suitable operation is achieved without a comparison between the input voltage U1 and the output voltage U2 being necessary. Information from outside as to whether the input voltage U1 is greater than the output voltage U2 or vice versa and a change in the driving of the switching states as a reaction to this information is thus not necessary. A flexible and rapid changeover between the two operating modes is therefore possible precisely in a transition region between step-up operation (boost mode) and step-down operation (buck mode).

The parameters which are necessary for the method, such as, for example, the first threshold current value Ival, the second threshold current value Ipk or the period duration Tc, can be obtained, for example, with the aid of an external controller (not illustrated) from the operating data of a device in which the DC-DC converter is used, for example of a current generating device. This may include, for example, MPPT data (maximum power point tracking) of a solar power system or the maximum current or the maximum voltage for charging a battery.

FIG. 8 shows a block diagram of a current generating device 100. The current generating device 100 contains a current generator 200, a DC-DC converter 300 and a current storage 400.

The current generator 200 supplies electrical energy at a variable DC voltage U1. It may be formed, for example, as a solar panel in which the DC voltage U1 depends on the momentary solar radiation and is therefore subject to great fluctuations.

The current storage 400 serves for storing the electrical energy supplied by the current generator 200. It may be formed, for example, as a chargeable battery. The charging voltages suitable for charging the battery are generally in a relatively narrow voltage range.

The DC-DC converter 300 serves for converting the DC voltage U1 supplied by the current generator 200 into a charging voltage U2 suitable for charging the battery. Depending on the magnitude of the DC voltage U1 momentarily supplied by the current generator 200, it must operate in step-up operation (boost mode) or in step-down operation (buck mode).

The DC-DC converter 300 contains a buck-boost converter 10, as described above, and a control device 20 which is configured or programmed to control the DC-DC converter 300 by means of the method described above with reference to FIG. 6.

The control device may be designed, for example, as a microcontroller. It contains a first digital/analog converter 31 for generating an analog value of the first threshold current value Ival and a second digital/analog converter 32 for generating an analog value of the second threshold current value Ipk. As described above, these values can be obtained, for example, via a digital controller from the operating data of the current generating device 100 and subsequently provided for the analog comparators by means of the digital/analog converters 31, 32.

The control device further contains a first comparator 41 for comparing a measured value of the measured coil current I with the first threshold current value Ival and a second comparator 42 for comparing a measured value of the measured coil current I with the second threshold current value Ipk. Depending on the comparison results, the central processing unit (CPU) 50 of the microcontroller generates the control signals for switching the switching elements S1-S4 with the time courses described above.

Hardware comparators of the microcontroller 20 are preferably used as comparators 41, 42, and the digital values of the threshold currents are written into the registers of these comparators 41, 42. Compared with a comparison by software, the speed is substantially increased, which is of particular importance for the time-critical switching of the switching elements.

The circuit is short-circuit-resistant on the output side because the coil current I is kept at a set value by the hardware. Since the hardware keeps the coil current I at the set value until the software specifies new reference values, the time requirement and the speed of the controller are not critical. The external controller can therefore run substantially more slowly and operate with a frequency which is lower than that which results from the period duration Tc of the switching cycles.

### LIST OF REFERENCE NUMERALS

1-7 switching cycles
10 buck-boost converter
20 control device
50 CPU
31, 32 digital/analog converter
41, 42 comparators
100 current generating device
200 current generator
300 DC voltage converter, DC-DC converter
400 current storage
BOOST ON, BOOST OFF, switching states
BUCK ON, BUCK OFF,
REFRESH
C1, C2 capacitors
D1-D4 freewheeling diodes
GND ground
I coil current
IN input terminal
Ipk second threshold current value
Ival first threshold current value
L inductor
OUT Output terminal
S1-S4 Switching elements
T1-T4 Switching transistors
Tc cycle duration, period duration
U1 input voltage
U2 output voltage

1. A method of operating a DC-DC converter which contains a buck-boost converter with an inductor (L) and a plurality of switching elements, wherein a step-up operation is achieved by alternating switching of the switching elements between a first switching state (BOOST ON) and a second switching state (BOOST OFF, BUCK ON) and a step-down operation is achieved by alternating switching between the second switching state (BOOST OFF, BUCK ON) and a third switching state (BUCK OFF), wherein the switching between the switching states takes place periodically in switching cycles with a predetermined period duration (Tc), wherein the method comprises:
measuring a current (I) flowing through the inductor (L),
performing the following method steps:
a) comparing the current (I) with a first threshold current value (Ival),
b) setting the buck-boost converter into the first switching state (BOOST ON) at the beginning of a switching cycle if the current (I) is below the first threshold current value (Ival), or setting the buck-boost converter into the second switching state (BOOST OFF, BUCK ON) at the beginning of the switching cycle if the current (I) is not below the first threshold current value (Ival),
c) if the buck-boost converter is operated in the first switching state (BOOST ON), comparing the current (I) with the first threshold current value (Ival) and setting the buck-boost converter into the second switching state (BOOST OFF, BUCK ON) as soon as the current (I) reaches the first threshold current value (Ival),
d) if the buck-boost converter is operated in the second switching state (BOOST OFF, BUCK ON), comparing the current (I) with a second threshold current value (Ipk) which is greater than the first threshold current value (Ival) and setting the buck-boost converter into the third switching state (BUCK OFF) as soon as the current (I) reaches the second threshold current value (Ipk), and
repeating steps a) to d) after expiry of the predetermined period duration (Tc).

2. The method of operating a DC-DC converter according to claim 1, wherein
the buck-boost converter is set into the first switching state (BOOST ON) before step a).

3. The method for operating a DC-DC converter according to claim 1, wherein
the buck-boost converter is set into a fourth switching state (REFRESH) at the end of the switching cycle before expiry of the predetermined period duration (Tc), which fourth switching state is configured for regenerating internal supply voltages of driver circuits for the switching elements connected to an input terminal (IN) or an output terminal (OUT) of the buck-boost converter.

4. The method of operating a DC-DC converter according to claims 1, wherein
the first threshold current value (Ival) and/or the second threshold current value (Ipk) and/or the predetermined period duration (Tc) are obtained from operating data of a device in which the DC-DC converter is used.

5. The method of operating a DC-DC converter according to claim 4, wherein
the operating data of the device comprise maximum power point tracking data of a current generator and/or the maximum current for charging a current storage and/or the maximum voltage for charging the current storage.

6. A DC-DC converter, comprising
a buck-boost converter with an inductor (L) and a plurality of switching elements, wherein a step-up operation is achieved by alternating switching of the switching elements between a first switching state (BOOST ON) and a second switching state (BOOST OFF, BUCK ON) and a step-down operation is achieved by alternating switching between the second switching state (BOOST OFF, BUCK ON) and a third switching state (BUCK OFF), and
a control device for controlling the DC-DC converter,
wherein the control device is configured or programmed to operate the DC-DC converter by means of a method according to claim 1.

7. The DC-DC converter according to claim 6, wherein
the buck-boost converter contains an input terminal (IN) for applying an input voltage (U1), an output terminal (OUT) for outputting an output voltage (U2) and a common ground (GND),
a first end of the inductor (L) is connected via a first switching element (S1) to the input terminal (IN) and via a second switching element (S2) to the ground (GND), and
a second end of the inductor (L) is connected via a third switching element (S3) to the output terminal OUT and via a fourth switching element (S4) to the ground GND.

8. The DC-DC converter according to claim 7, wherein
in the first switching state (BOOST ON), the second and the third switching element (S2, S3) are opened and the first and the fourth switching element (S1, S4) are closed and/or
in the second switching state (BOOST OFF, BUCK ON), the second and the fourth switching element (S2, S4) are opened and the first and the third switching element (S1, S3) are closed and/or
in the third switching state (BUCK OFF), the first and the fourth switching element (S1, S4) are opened and the second and the third switching element (S2, S3) are closed and/or
in the fourth switching state (REFRESH), the first and the third switching element (S1, S3) are opened and the second and the fourth switching element (S2, S4) are closed.

9. The DC-DC converter according to claim 6,
wherein the control device contains a microcontroller.

10. The DC-DC converter according to claim 9, wherein
the comparison of the current (I) with the first threshold current value (Ival) and/or with the second threshold current value (Ipk) is carried out by means of comparators integrated in the hardware of the microcontroller.

11. A power generation system, comprising
a current generator for generating electrical energy at a first voltage (U1),
a current storage for storing the electrical energy generated by the current generator at a second voltage (U2) and
the DC-DC converter according to claim 6.

12. A computer program stored in a non-transitory computer-readable medium having instructions which cause a control unit to generate control signals for carrying out a method according to claim 1 when the computer program is executed in the control unit.
